(19) United States
(12) Patent Application Publication
(10) Pub. No.: US 2002/0082019 A1
(43) Pub. Date: Jun. 27, 2002

(54) METHODS AND APPARATUS FOR ACCOMPLISHING INTER-FREQUENCY, INTER-NETWORK, AND INTER-TIER SOFT HANDOFF USING DUAL TRANSMISSION/RECEPTION OR COMPRESSION

(76) Inventors: OGUZ SUNAY, IRVING, TX (US); ARI HOTTINEN, ESPOO (FI)

Correspondence Address: ALTERA LAW GROUP, LLC, 6500 CITY WEST PARKWAY, SUITE 100, MINNEAPOLIS, MN, 55344, US

(21) Appl. No.: 09/223,555

(22) Filed: Dec. 30, 1998

(51) Int. Cl. H04Q 7/20

(52) U.S. Cl. 455/442

(57) ABSTRACT

Methods and apparatus for accomplishing inter-frequency, inter-network, and inter-tier soft handoff are disclosed which use dual transmission/reception or compression techniques. The invention includes a transceiver disposed between a user interface and an antenna interface. The transceiver links the antenna and the user interface by monitoring signals at a mobile station received via the antenna from a plurality of wireless communication network types, determining a best candidate for soft handoff based upon the monitored signals, the best candidate being associated with one of the plurality of wireless communication network types and performing a handoff to the best candidate. One embodiment of the invention includes a first receiver operating at a first frequency, a second receiver operating a second frequency, a first transmitter operating at the first frequency and a second transmitter operating at the second frequency, wherein the first receiver receives signals from a first type of wireless communication network type at the first frequency and the second receiver receives signals from a second type of wireless communication network type at the second frequency. The transceiver monitors the first half of a normal frame sequence period for a first transmission frame being transmitted at the first frequency and a second half of a normal frame sequence period for a second transmission frame being transmitted at the second frequency. The first transmission frame may be power control bits, pilot strength signals or voice signals.

### BACKGROUND OF THE INVENTION

1. Field of the Invention

This invention relates in general to a communications system, and more particularly to methods and apparatus for accomplishing inter-frequency, inter-network, and inter-tier soft handoff using dual transmission/reception or compression.

2. Description of Related Art

Since the invention of the telephone, users have desired untethered communication in order to exchange information wherever and whenever they wanted. The growth of the transportation network led to increased use of cars and airplanes for business and pleasure. With the growth in the transportation network, workers commuted to and from their homes to employment centers. This led to increased congestion and as much time being spent on the road as at the home and office. Naturally, these workers desired access to services such as voice, fax and data to effectively use their time on the road. The wireless/mobile telecommunications industry has emerged to satisfy these desires.

The demand by consumers all over the world for mobile communications is expanding at a rapid pace and will continue to do so for at least the next decade. Over 100 million people were using a mobile service by the end of 1995, and that number is expected to grow to 300 million by the year 2000. Several factors are contributing to the exciting growth in the telecommunications industry. For example, a combination of technology and competition bring more value to consumers. Phones are smaller, lighter, have a longer battery life, and are affordable now for the mass market. Operators are providing excellent voice quality, innovative services, and roaming across the country or world. Most important, mobility is becoming less expensive for people to use. Around the world, as well as in the United States, governments are licensing additional spectrum for new operators to compete with traditional cellular operators. Competition brings innovation, new services, and lower prices for consumers.

FIG. 1 illustrates a basic, generic wireless telecommunication system 100. This system can be broken down to blocks as shown in FIG. 1. The human voice fed to the microphone of a handset 110 is transmitted through the atmosphere 112 to the Base Station 114. From the Base Station 114, the signal is routed to a switching center 116 or rebroadcast 118. Similarly, at the network end the voice information is transmitted from the Base Station 120 and received by the handset 122. Each handset 110, 112 and Base Station 114, 120 have the transmitter/receiver (transceiver) function.

Prior to the cellular concept, the approach to providing mobile services was similar to the approach taken by radio and television stations. The operators set up huge transmitters at the highest point in a geographic area. Then they sent high-powered transmissions resulting in a large coverage area. The consequence of this was twofold: 1) there was a capacity problem; and 2) the Mobile Stations consumed a large amount of power. Therefore, the Mobile Stations were very bulky and expensive.

The solution to this problem is to decrease the power of transmission, thereby reducing the coverage area of the transmitter. Because the range of each area is small, a large area may be divided into several smaller areas called cells. Each cell may have its own antenna, a set of frequencies, and transmitter/receiver radio units.

Accordingly, in cellular networks, unlike in the old mobile architecture, there were multiple cells covering an area. Hence, calls had to be passed as the vehicle or mobile unit moved from one cell to another. This is called handoff. FIG. 2 illustrates a handoff process. As a vehicle 210 moved away from Base Station 212, its signal strength decreases. The Base Station 212 monitored the signal strength during the duration of the call. When signal strength fell below a predetermined threshold level the network 214 asked all predetermined candidates neighboring cells 220 to report the signal strength of the Mobile Station in the vehicle 210. If the signal strength in the neighboring cell 220 was stronger by a predetermined amount, then the network 214 attempted to handoff the call to the candidate neighboring cell 220. Today the cellular system refers to these three basic elements as a Mobile Station 210 cell sites 202, 220 and Mobile Switching Centers. These three elements are integrated to form a ubiquitous coverage radio system that can connect to the public switched telephone network 240.

There are several types of cellular systems throughout the world. One such system in the United States is the code division multiple access (CDMA) system, which is based on the IS-95 industry specification. IS-95 CDMA combines new digital spread spectrum CDMA and advanced mobile phone service (AMPS) functionality into one dual-mode cellular telephone on the 800 MHz band, and can use a CDMA-only handset on the 1.9 GHz PCS band. CDMA systems primarily differ from FDMA (Analog) and TDMA systems through the use of coded radio channels. In a CDMA system, users can operate on the same radio channel simultaneously by using different coded sequences.

IS-95 CDMA cellular systems have several key attributes that are different from other cellular systems. The same CDMA radio carrier frequencies may be optionally used in adjacent cell sites, which eliminates the need for frequency planning. FIG. 3 illustrates a CDMA cellular system exhibiting frequency re-use 300 and a system that does not exhibit frequency re-use 350. In FIG. 3, each cell in the frequency re-use network 300 uses the same frequencies as illustrated by the reference number “1” 312 within each cell. In contrast, FIG. 3 also illustrates an AMPS cellular network 350 wherein the available spectrum is divided into seven frequency blocks and each block is used in an individual cell. In the AMPS network 350, the same frequency blocks, e.g., 352, 354, are separated by distance to avoid co-channel interference.

The wide band radio channel of CDMA provides less severe fading, which results in more consistent quality voice transmission under varying radio signal conditions. The CDMA system is compatible with the established access technology, and it allows analog (EIA-553) and dual mode (ID-95) subscribers to use the same analog control channels. Some of the voice channels have been converted to CDMA digital transmissions, allowing several users to be multiplexed (shared) on a single RF channel.

As stated above, in AMPS cellular systems, handoff occurs when the Base Station detects a deterioration in signal strength from the Mobile Station. As AMPS subscribers approach handoff; signal strength may vary abruptly and the voice is muted for at least 200 milliseconds in order to send control messages and complete the handoff. In contrast, CDMA uses a unique soft handoff; which is nearly undetectable and loses few if any information frames. As a result, CDMA's soft handoff is much less likely to lose a call during handoff.

During Soft Handoff, Mobile Station units in transition between one cell and its neighbor transmit to and receive the same signal from both Base Stations simultaneously. With CDMA, a RAKE receiver in the Mobile Station can be used to isolate the signals from each Base Stations and align them both in time and phase to reinforce one another on the forward link. On the reverse link, the MSC must resolve which Base Station is receiving the stronger and hence the better replica and decide in its favor. Decisions as to when to enter the soft handoff and when to release the weaker signal depend on the relative signal strengths.

Most soft handoff algorithms have concentrated on the scenario where the CDMA system of interest employs universal frequency re-use. In this scenario, all cells operate in the same frequency. Furthermore, soft handoffs occur only within the same cellular system and when all the Base Stations are in the same area.

FIG. 4 illustrates the typical message exchanges between the Mobile Station and the Base Station during soft handoff for the 15-95 and ANSI-008 standards. In FIG. 4, a received pilot strength signal 400 from a Base Station other than the one that the Mobile Station is currently communicating is illustrated. During the soft handoff, at time t₁ 410, the pilot strength 412 exceeds T_ADD 414. The Mobile Station then sends a Pilot Strength Measurement Message and transfers the pilot to the Candidate Set. At time t₂ 420 the Base Station sends a Extended Handoff Direction Message. At time t₃ 430 the Mobile Station transfers pilot to the Active Set successfully and sends a Handoff Complete Message. At time t₄ 440 the pilot strength 442 drops below T_DROP 444 and the Mobile Station starts the handoff drop timer. At time t₅ 450 the handoff timer expires and the Mobile Station sends a Pilot Strength Measurement Message. At time t₆ 460 the Base Station sends an Extended Handoff Direction Message. Finally, at time t7 470 the Mobile Station moves the pilot from the Active Set to the Neighbor Set and sends a Handoff Complete Message.

In FIG. 4, the Mobile Station is in soft handoff between times t₃ 430 and t₇ 470. During this time, the Mobile Station receives traffic channels from both Base Stations and messages from the Mobile Station are received and processed by both Base Stations. However, if the two Base Stations in question are operating in different frequencies, the above procedure will not be realizable. This is because, the IS-95 or ANSI-008 Mobile Station can only operate at one frequency band at a time and unlike TDMA systems, CDMA systems require continuous signaling. With the increase in the number of customers in CDMA based systems, it will soon be necessary for the operators to provide service in multiple frequency bands. This inherently introduces the question as to whether soft handoff between neighboring Base Stations that operate at different frequency bands is realizable.

FIG. 5 illustrates two CDMA networks co-located. In FIG. 5, the first network is perfectly overlayed with the second network. This is represented by each cell including reference numbers “1” 510 and “2” 512. Those skilled in the art will recognize that the size and position of the cells in the second network may actually differ from the cells in the second network. As can be appreciated, soft handoff between a cell in the first CDMA network to a cell in the second CDMA network is not permissible with current soft handoff algorithms. Nevertheless, soft handoff between two CDMA networks co-located may be desired in the future.

Finally, handoff between different tiered systems is not supported by current soft handoff algorithms. In the discussion above, AMPS, TDMA, and CDMA networks have been described. These networks have been designed for ubiquitous nationwide mobile traffic. These technologies, along with other technologies such as D-AMPS, GSM/PCS 1800, can be termed high-tier communications systems. However, there are several other wireless applications, such as cordless telephones, wireless PBXs, and wireless pay phones. These applications may be termed low-tier communication systems.

There are fundamental differences between the operating conditions of the different tiered communication systems, such as power differences. Further, current users employ different handsets for each tier. However, ubiquitous handsets for use in low-tier and high-tier networks may be produced in the future. As such, in inter-tier soft handoff is another concern due to the operating power differences between the two tiers.

It can be seen that there is a need for a method and apparatus that enables frequency, inter-network, and inter-tier soft handoff.

### SUMMARY OF THE INVENTION

To overcome the limitations in the prior art limitations that will become apparent upon reading specification, the present invention discloses methods and apparatus for accomplishing inter-frequency, inter-network, and inter-tier soft handoff.

The present invention solves the above-described problems by using dual transmission/reception or compression techniques in connection with enhanced power control to accomplish inter-frequency, inter-network, and inter-tier soft handoffs.

A system in accordance with the principles of the present invention includes an antenna interface for coupling RF signals from an antenna and the transmission media, a user interface for providing a display and a user input to allow a user to send and receive RF signals and a transceiver disposed between the user interface and the antenna interface, the transceiver linking the antenna and the user interface by monitoring signals at a mobile station received via the antenna from a plurality of wireless communication network types, determining a best candidate for soft handoff based upon the monitored signals, the best candidate being associated with one of the plurality of wireless communication network types and performing a handoff to the best candidate.

Other embodiments of a system in accordance with the principles of the invention may include alternative or optional additional aspects. One such aspect of the present invention is that wherein the transceiver further includes a first receiver operating at a first frequency, a second receiver operating a second frequency, a first transmitter operating at the first frequency and a second transmitter operating at the second frequency.

Another aspect of the present invention is that the first receiver receives signals from a first type of wireless communication network type at the first frequency and the second receiver receives signals from a second type of wireless communication network type at the second frequency.

Another aspect of the present invention is that the transceiver further includes a processor for performing RAKE processing, the processor isolating the signals from the first and second receivers, aligning the signals from the first and second receivers in time and phase.

Still another aspect of the present invention is that wherein the first transmitter transmits signals to a first type of wireless communication network type at the first frequency and the second transmitter transmits signals to a second type of wireless communication network type at the second frequency.

Another aspect of the present invention is that the transceiver further includes a signal processor coupled to the first and second receivers, the signal processor monitoring a first half of a normal frame sequence period for a first transmission frame being transmitted at the first frequency and a second half of a normal frame sequence period for a second transmission frame being transmitted at the second frequency.

Another aspect of the present invention is that the first transmission frame includes power control bits from a first type of wireless communication network type at the first frequency and second transmission frame includes power control bits from a second type of wireless communication network type at the second frequency.

Yet another aspect of the present invention is that the transceiver further includes a signal processor, the signal processor monitoring a first half of a normal frame sequence period for a first transmission frame being transmitted at a first power level and a second half of a normal frame sequence period for a second transmission frame being transmitted at a second power level.

Another aspect of the present invention is that the first transmission frame includes power control bits from a first type of wireless communication network type at the first frequency and second transmission frame includes power control bits from a second type of wireless communication network type at the second frequency.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof; and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a basic, generic wireless telecommunication system;

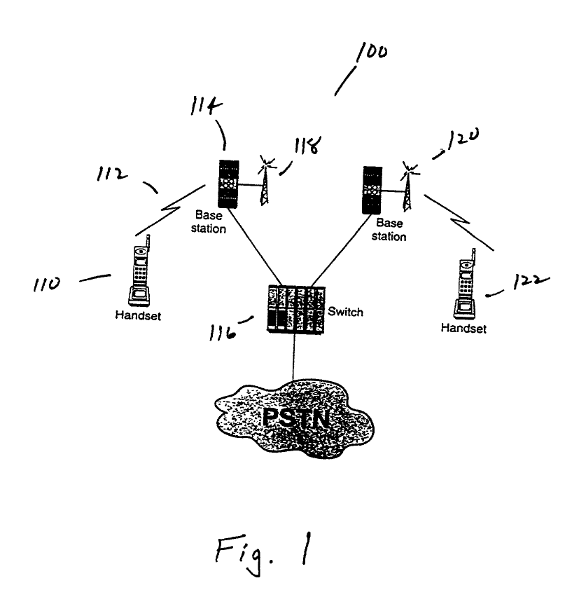

FIG. 2 illustrates a handoff process as a vehicle moves away from a Base Station;

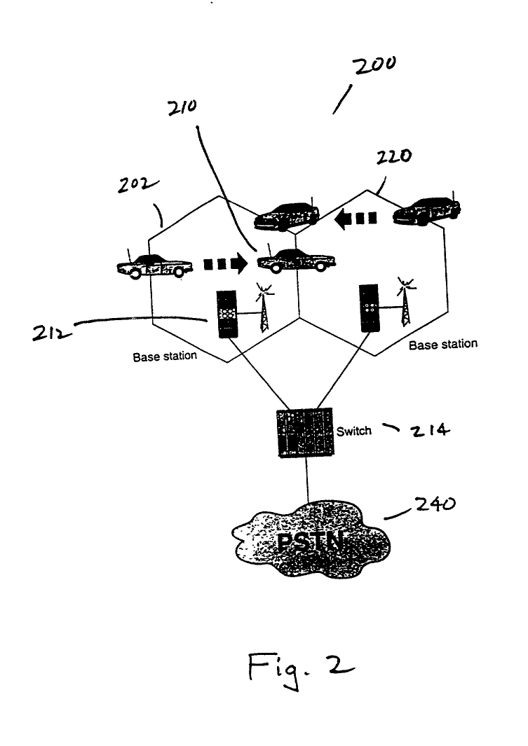

FIG. 3 illustrates a CDMA cellular system exhibiting frequency re-use and a system that does not exhibit frequency re-use;

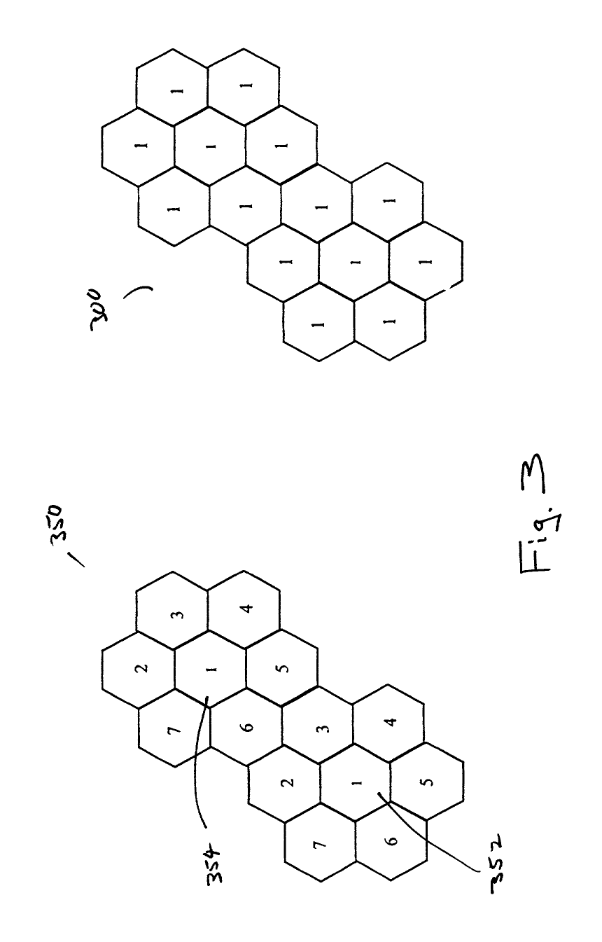

FIG. 4 illustrates the typical message exchanges between the Mobile Station and the Base Station during soft handoff for the 15-95 and ANSI-008 standards;

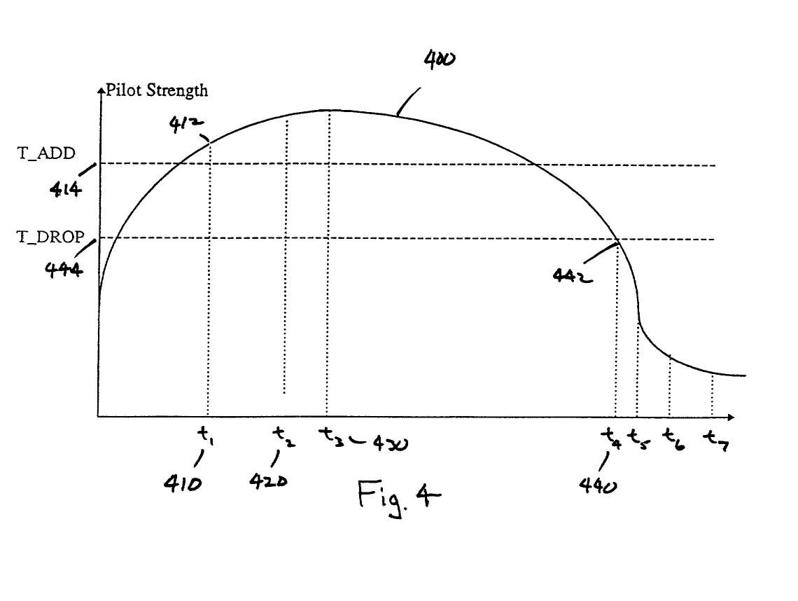

FIG. 5 illustrates two CDMA networks co-located;

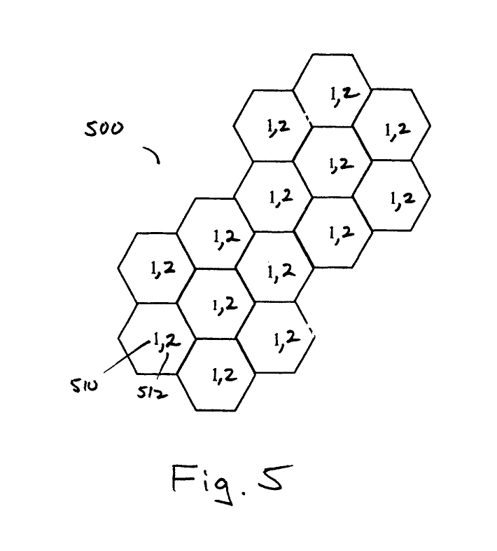

FIG. 6 illustrates a block diagram of a typical Mobile Station;

FIG. 7 illustrates a dual receiver for monitoring frequencies f1 and f2;

FIG. 8 illustrates a Message Source having access to a first transmitter operating at the first frequency f1 and a second transmitter operating at the second frequency f2 for enabling a soft handoff;

FIGS. 9a and 9b illustrate a flow chart of a soft handoff in accordance with the dual transceiver;

FIG. 10 shows frame sequences for illustrating the burst transmission technique; and

FIG. 11 illustrates the time variance of the loop power control.

### DETAILED DESCRIPTION OF THE INVENTION

In the following description of the exemplary embodiment, reference is made to the accompanying drawings which form a part hereof; and in which is shown by way of illustration the specific embodiment in which the invention may be practiced. It is to be understood that other embodiments may be utilized as structural changes may be made without departing from the scope of the present invention.

The present invention provides a method and apparatus that provides inter-frequency, inter-network, and inter-tier soft handoff.

When two Base Stations that operate on different frequencies are to provide a soft handoff service to a given Mobile Station, two major alternatives exist. The necessary changes can be realized in the hardware or software. A first alternative involves the use of dual transmitter/receiver Mobile Stations. Traditionally, initially it was believed that dual receiver Mobile Stations for CDMA systems would be too costly, require significant hardware alterations and therefore never be required in any of the standards. The on-going work on the Japanese Wideband CDMA Standardization process seems to be proving this belief wrong. If dual transmitter/receiver Mobile Stations become a reality, an inter-frequency soft handoff may easily become a reality.

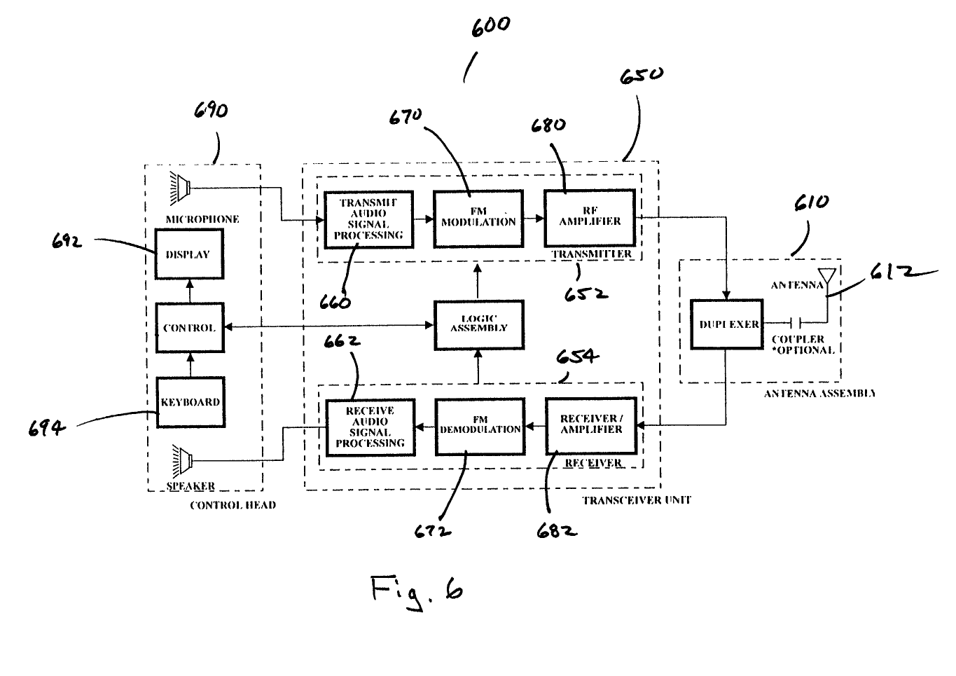

FIG. 6 illustrates a block diagram of a typical Mobile Station 600. The Mobile Station includes an antenna assembly 610, a transceiver unit 650 and a user interface 690 in one physical package. The radio transceiver 650 converts audio to a radio frequency (RF) signal and RF signals into audio and includes a transmitter 652 and a receiver 654, wherein the transmitter 652 and receiver 654 further include signal processors 660, 662, modulator 670/demodulators 672 and amplifiers 680, 682. The signal processors 660, 662 may perform RAKE processing in the Mobile Station 600 to isolate the signals from a plurality of Base Stations and align them in time and phase to reinforce each other. The user interface 690 provides the display 692 and keypad 694 which allow the subscriber to communicate commands to the transceiver 650. The antenna assembly 610 couples RF energy between the electronics of the transceiver 650 with the Mobile Station and the outside “air” for transmission and reception via an antenna 612.

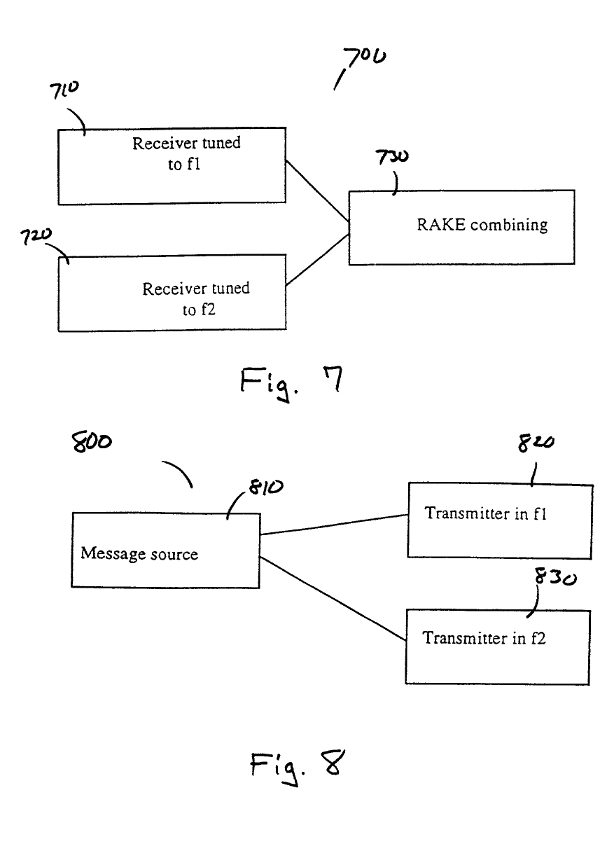

In a dual transmitter/receiver Mobile Station, the Mobile Station will have the capability to monitor two frequencies. FIG. 7 illustrates a dual receiver 700 for monitoring frequencies f1 and f2 when it is in Idle State and Traffic State. In the Traffic State, for example, assume that the Mobile Station is communicating with a first Base Station that operates at a first frequency, f1. To this end, a first receiver 710 is tuned to receiver the signal at the first frequency f1 from the first Base Station. During this time, the Mobile Station may use the spare receiver 720 to continue monitoring the other frequency f2. The receiver 710 that is used to receive the first Base Station signal at the first frequency f1 is also used to monitor the other pilots in the same frequency.

Once one of the pilots from a second Base Station at the second frequency f2 exceeds T_ADD_f2 (note that this value has to be frequency band specific) in strength, the Mobile Station sends a Pilot Strength Measurement Message to the first Base Station. The first Base Station in return, sends an Extended Handoff Direction Message to initiate the inter-frequency soft handoff. Once the Mobile Station receives this message, the Mobile Station adds the second Base Station into its Active Set and sends a Handoff Completion Message. Now, the Mobile Station starts using both of its receivers 710, 720 to receive the signals from both frequencies f1, and f2 as shown in FIG. 7.

Once the two signals are isolated, taken to a common frequency (this common frequency may be baseband as well) and time and phase aligned, the two signals can be combined using a RAKE receiver 730 to reinforce each of the two signals.

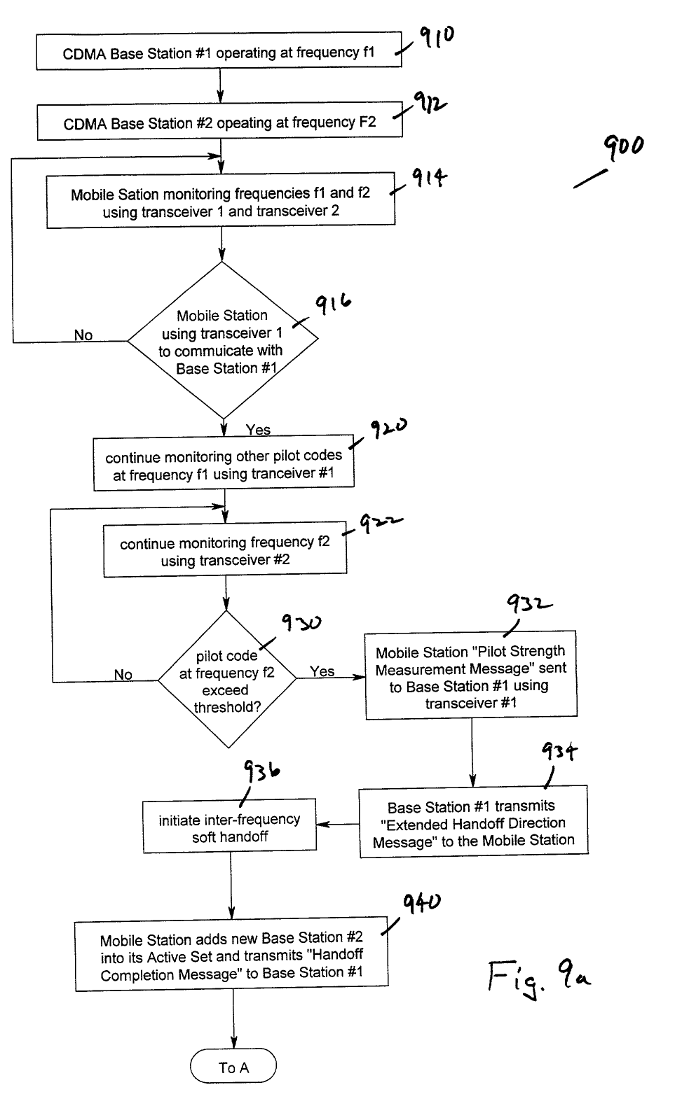

The dual receiver/transmitter Mobile Station also needs to transmit the same message in both frequencies 800 to enable the soft handoff uplink as shown in FIG. 8. In FIG. 8, the Message Source 810 has access to either transmitter: a first transmitter 820 operating at the first frequency f1 and a second transmitter 830 operating at the second frequency f2. To complete the soft handoff, the MSC must resolve which of the two Base Stations is receiving the stronger and hence better replica and decide in its favor. The two replicas may also be combined before transmission to the network.

Power control in inter-frequency soft handoff is also an issue. When the Mobile Station has two transmitters, each transmitter can be power controlled by the corresponding Base Station within the same CDMA channel. The initial power (open loop) is determined from pilot measurements separately. Those skilled in the art will recognize that the present invention is not meant to be limited to the particular embodiments described above, but that other embodiments are possible, including a co-located system wherein the power is controlled jointly by the two frequencies.

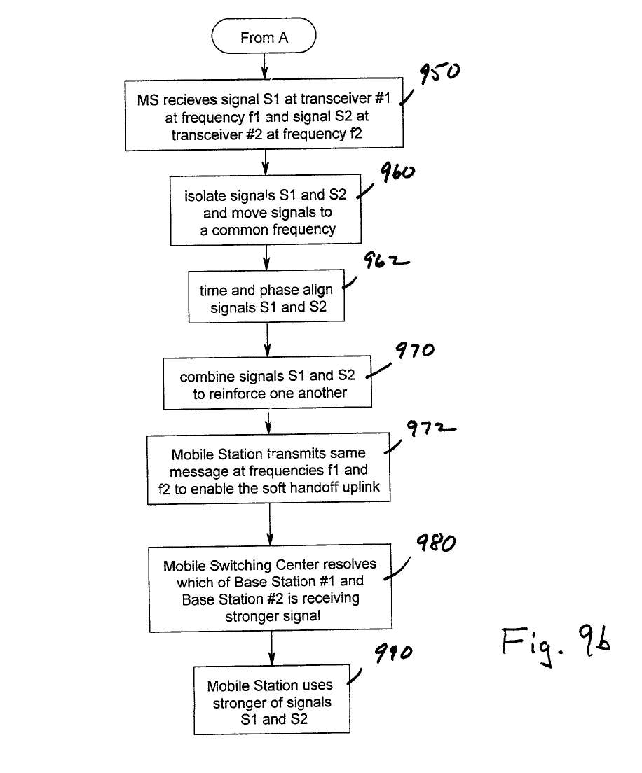

FIGS. 9a and 9b illustrate a flow chart 900 of a soft handoff in accordance with the dual transceiver discussed with reference to FIGS. 7 and 8. A first and second CDMA Base Station are operating at frequencies f1 910 and f2 920 respectively. The Mobile Station monitors these frequencies 914. The Mobile Station uses the first transceiver to communicate with the first Base Station 916 and continues to monitor other pilot codes at frequency f1 using the first transceiver 920. The Mobile Station also continues to monitor the second frequency f2 using the second transceiver 922. When the pilot code at the second frequency f2 exceeds a threshold 930, the Mobile Station sends a Pilot Strength Measurement Message to the first Base Station using the first transceiver 932.

Next the first Base Station transmits an Extended Handoff Direction Message 934 to initiate the inter-frequency soft handoff 936. Once the Mobile Station receives this message, the Mobile Station adds the new second Base Station into its Active Set and sends a Handoff Completion Message to the first Base Station 940. Now, the Mobile Station starts using both of its receivers to receive the signals from both frequencies f1 and f2 950. Once the two signals are isolated and taken to a common frequency 960 (this common frequency may be baseband as well) and time and phase aligned 962, the two signals can be combined to reinforce each of the two signals 970. The Mobile Station also transmits the same message in both frequencies, f1 and f2, to enable the soft handoff uplink 972. The MSC then resolves which of the two Base Stations is receiving the stronger and hence better replica 980 and decide in its favor 990.

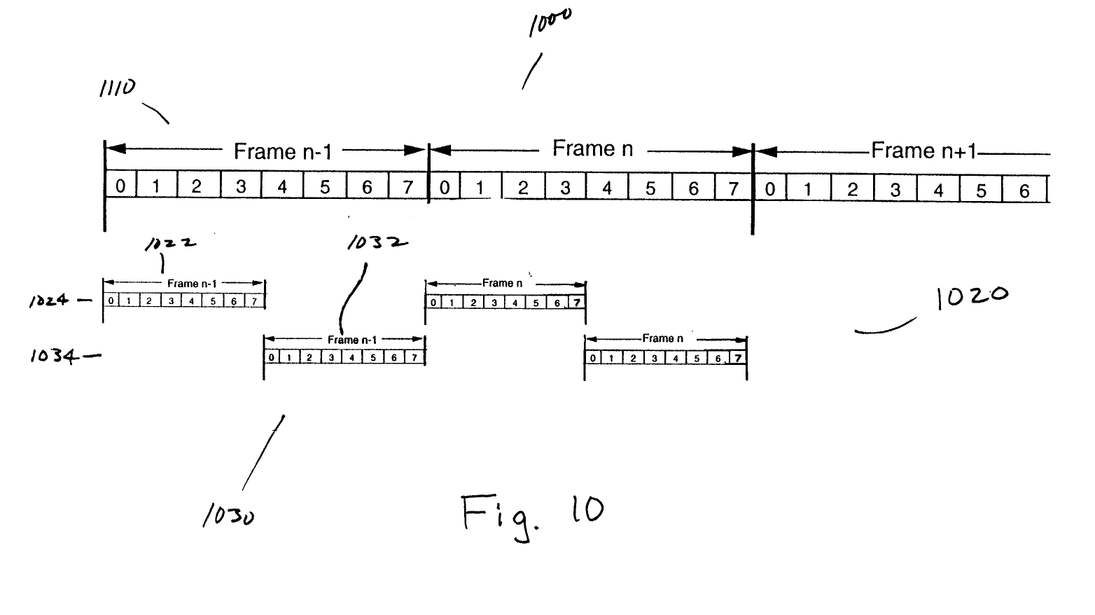

Even if the Mobile Station in question does not have the hardware capabilities to transmit and receive in multiple frequencies simultaneously, it may still be possible to realize inter-frequency soft handoff using a burst transmission technique. FIG. 10 shows frame sequences for illustrating the burst transmission technique 1000. To realize inter-frequency soft handoff using a burst transmission technique, the normal transmission rate 1010 of the Mobile Station and the Base Stations is temporarily doubled 1020. In this technique, in the uplink, one transmission frame 1022 is sent in half the time at the first frequency f1 1024. In the second time slot 1030, the contents of the frame 1032 is transmitted at the second frequency f2 1034.

Similarly, in the downlink, the Base Stations need to coordinate their signals so that the Mobile Station may receive the message from the Base Station operating in f1 in the first half of the time frame and the message from the Base Station operating in f2 in the second half of the time frame. The Base Stations, may sit idle the other half of the time period or if such a strict coordination is not desired, the Base Stations may be asked to transmit the same signal twice during the burst and the Mobile Station can select any one of the two time frames to monitor.

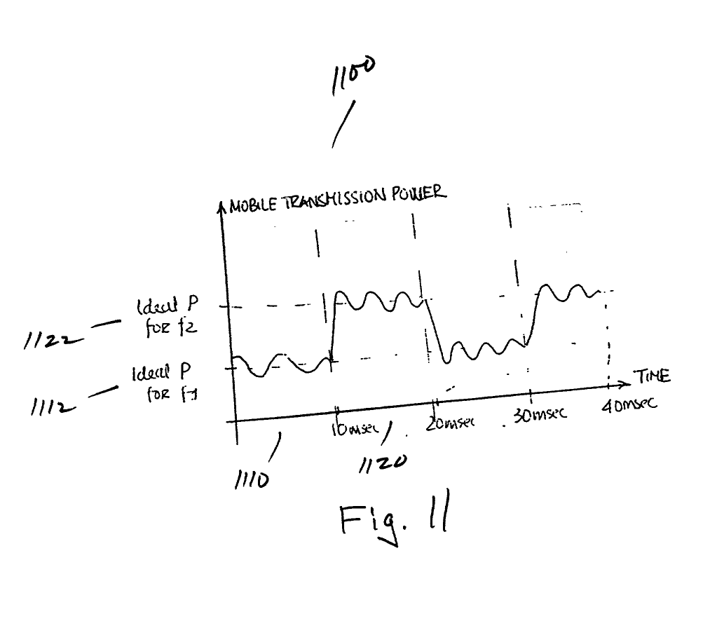

When the inter-frequency soft handoff is realized using burst, the closed loop power control will be time variant. FIG. 11 illustrates the time variance of the loop power control 1100. During a first time sequence 1110, the ideal power for f1 is transmitted 1112. During the second time sequence 1120 the ideal power for f2 is transmitted 1122. The Mobile Station will adjust its transmission power according to the message it gets from one of the Base Stations that is transmitting for that Mobile Station and when it tunes to the other band, it adjusts its power according to the other Base Station. Note that the transmission power of the Mobile Station will not be continuous since the transmission power requirements for different frequency bands may be different. So, the power transmission characteristics will be somewhat of a periodic nature. In addition to inter-frequency soft handoffs, two CDMA networks co-located may be desired to provide soft handoff in the future. The above two techniques would be sufficient to realize this goal.

If inter-tier soft handoff is desired, the operating power differences between the two tiers must be accounted for during the handoff. If not controlled, an inter-tier soft handoff may cause near-far problem or call drops. As long as the power control for the transmission for different tiers are done independently, this may not be a big issue. This is done, as explained above, with reference to FIGS. 7 and 8, i.e., by establishing independent power control algorithms for the transmitters of the Mobile Station if it is a dual transmitter Mobile Station, or with reference to FIGS. 10 and 11, i.e., by establishing time variant power control algorithms if burst is used. Once power control is taken care of, the above modifications will enable inter-tier soft handoff as well.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A method for accomplishing inter-frequency, inter-network, and inter-tier soft handoff comprising the steps of:
monitoring signals at a mobile station from a plurality of wireless communication network types;
determining a best candidate for soft handoff based upon the monitored signals, the best candidate being associated with one of the plurality of wireless communication network types; and
performing a handoff to the best candidate.

2. The method of claim 1 wherein the signals are pilot strength signals from the plurality of wireless communication network types.

3. The method of claim 2 wherein the step of monitoring further comprises the steps of receiving a first set of pilot strength signals from at least one base station associated with a first wireless communication network type and receiving a second set of pilot strength signals from at least one base station associated with a second wireless communication network type.

4. The method of claim 3 wherein the pilot strength signals from the at least one base station associated with the first wireless communication network type comprises a first transmission frequency and the pilot strength signals from the at least one base station associated with the second wireless communication network type comprises a second transmission frequency.

5. The method of claim 4 wherein the step of receiving the first set of pilot strength signals further comprises the step of receiving the first set of pilot strength signals using a first receiver operating at a first frequency and wherein the step of receiving the second set of pilot strength signals further comprises the step of receiving the second set of pilot strength signals using a second receiver operating at a second frequency.

6. The method of claim 3 wherein the step of receiving the first set of pilot strength signals further comprises the step of monitoring a first half of a normal frame sequence period for a first transmission frame being transmitted at a first frequency and a second half of a normal frame sequence period for a second transmission frame being transmitted at a second frequency.

7. The method of claim 3 wherein the first set of pilot strength signals from the at least one base station associated with the first wireless communication network type include a first power characteristic and the pilot strength signals from the at least one base station associated with the second wireless communication network type include a second power characteristic.

8. The method of claim 7 wherein the step of receiving the first set of pilot strength signals further comprises receiving the first set of pilot strength signals using a first receiver operating at a first power characteristic and wherein the step of receiving the second set of pilot strength signals further comprises receiving the second set of pilot strength signals using a second receiver operating at a second power characteristic.

9. The method of claim 7 wherein the step of receiving the first set of pilot strength signals further comprises the step of monitoring a first half of a normal frame sequence period for a first transmission frame being transmitted at a first power characteristic and a second half of a normal frame sequence period for a second transmission frame being transmitted at a second power characteristic.

10. The method of claim 1 wherein the signals comprise power control bits from the plurality of wireless communication network types for controlling a transmission power of the mobile station.

11. The method of claim 10 wherein the step of monitoring further comprises the steps of receiving a first set of power control bits from at least one base station associated with a first wireless communication network type and receiving a second set of power control bits from at least one base station associated with a second wireless communication network type.

12. The method of claim 11 wherein the first set of power control bits from the at least one base station associated with the first wireless communication network type comprises a first transmission frequency and the second set of power control bits from the at least one base station associated with the second wireless communication network type comprises a second transmission frequency.

13. The method of claim 12 wherein the step of receiving the first set of power control bits further comprises the step of receiving the first set of power control bits using a first receiver operating at a first frequency and wherein the step of receiving the second set of power-control bits further comprises the step of receiving the second set of power control bits using a second receiver operating at a second frequency.

14. The method of claim 11 wherein the step of receiving the first set of power control bits further comprises the step of monitoring a first half of a normal frame sequence period for a first transmission frame being transmitted at a first frequency and a second half of a normal frame sequence period for a second transmission frame being transmitted at a second frequency.

15. The method of claim 11 wherein the first set of power control bits from the at least one base station associated with the first wireless communication network type include a first power characteristic and the second set of power control bits from the at least one base station associated with the second wireless communication network type include a second power characteristic.

16. The method of claim 15 wherein the step of receiving the first set of power control bits further comprises receiving the first set of power control bits using a first receiver operating at a first power characteristic and wherein the step of receiving the second set of power control bits further comprises receiving the second set of power control bits using a second receiver operating at a second power characteristic.

17. The method of claim 15 wherein the step of receiving the first set of power control bits further comprises the step of monitoring a first half of a normal frame sequence period for a first transmission frame being transmitted at a first power characteristic and a second half of a normal frame sequence period for a second transmission frame being transmitted at a second power characteristic.

18. A mobile station, comprising:
an antenna interface for coupling RF signals from an antenna and the transmission media;
a user interface for providing a display and a user input to allow a user to send and receive RF signals; and
a transceiver disposed between the user interface and the antenna interface, the transceiver linking the antenna and the user interface by monitoring signals at a mobile station received via the antenna from a plurality of wireless communication network types, determining a best candidate for soft handoff based upon the monitored signals, the best candidate being associated with one of the plurality of wireless communication network types and performing a handoff to the best candidate.

19. The mobile station of claim 18 wherein the transceiver further comprises a first receiver operating at a first frequency, a second receiver operating a second frequency, a first transmitter operating at the first frequency and a second transmitter operating at the second frequency.

20. The mobile station of claim 18 wherein the first receiver receives signals from a first type of wireless communication network type at the first frequency and the second receiver receives signals from a second type of wireless communication network type at the second frequency.

21. The mobile station of claim 20 wherein the transceiver further includes a processor for performing RAKE processing, the processor isolating the signals from the first and second receivers, aligning the signals from the first and second receivers in time and phase.

22. The mobile station of claim 19 wherein the first transmitter transmits signals to a first type of wireless communication network type at the first frequency and the second transmitter transmits signals to a second type of wireless communication network type at the second frequency.

23. The mobile station of claim 19 wherein the transceiver further comprises a signal processor coupled to the first and second receivers, the signal processor monitoring a first half of a normal frame sequence period for a first transmission frame being transmitted at the first frequency and a second half of a normal frame sequence period for a second transmission frame being transmitted at the second frequency.

24. The mobile station of claim 23 wherein the first transmission frame comprises power control bits from a first type of wireless communication network type at the first frequency and second transmission frame comprises power control bits from a second type of wireless communication network type at the second frequency.

25. The mobile station of claim 19 wherein the transceiver further comprises a signal processor, the signal processor monitoring a first half of a normal frame sequence period for a first transmission frame being transmitted at a first power level and a second half of a normal frame sequence period for a second transmission frame being transmitted at a second power level.

26. The mobile station of claim 25 wherein the first transmission frame comprises power control bits from a first type of wireless communication network type at the first frequency and second transmission frame comprises power control bits from a second type of wireless communication network type at the second frequency.
